(19) United States
(12) Patent Application Publication
(10) Pub. No.: US 2013/0037209 A1
(43) Pub. Date: Feb. 14, 2013

(54) OPTICAL FIBER CONNECTION METHOD AND OPTICAL FIBER CONNECTING DEVICE

(71) Applicants: Kenichi OHHASHI, Hitachi (JP); Jyuhyun YU, Mito (JP); Naoto TERAKI, Takahagi (JP); Kouki HIRANO, Hitachinaka (JP)

(72) Inventors: Kenichi OHHASHI, Hitachi (JP); Jyuhyun YU, Mito (JP); Naoto TERAKI, Takahagi (JP); Kouki HIRANO, Hitachinaka (JP)

(73) Assignee: HITACHI CABLE, LTD., TOKYO (JP)

(21) Appl. No.: 13/567,194

(22) Filed: Aug. 6, 2012

(30) Foreign Application Priority Data
Aug. 12, 2011 (JP) 2011-176609

(51) Int. Cl. B32B 37/14; B32B 37/12; G02B 6/38

(52) U.S. Cl. 156/275.7; 385/70; 156/293

(57) ABSTRACT

An optical fiber connection method for connecting an optical fiber to an optical waveguide on a circuit board, including arranging an end portion of the optical fiber along a groove such that an end face of the optical fiber contacts with a core end face of the optical waveguide, the groove being formed on the circuit board and extending to the core end face of the optical waveguide, wherein an extended portion of the optical fiber extending out of the groove is arranged being inclined at a predetermined inclination angle with respect to the circuit board, pressing an optical fiber hold-down member against the circuit board by a pressing member, the optical fiber hold-down member being arranged on the circuit board via an adhesive so as to cover the end portion of the optical fiber, and curing the adhesive while pressing the optical fiber hold-down member against the circuit board.

The present application is based on Japanese patent application No. 2011-176609 filed on Aug. 12, 2011, the entire contents of which are incorporated herein by reference.

### BACKGROUND OF THE INVENTION

1. Field of the Invention

The invention relates to an optical fiber connection method for connecting an optical fiber to an optical waveguide provided on a circuit board, and an optical fiber connecting device.

2. Description of the Related Art

When an optical fiber is used as an optical signal transmission medium, a photoelectric conversion module for converting an electric signal into an optical signal, or vice versa, is required. For example, in a photoelectric conversion module disclosed in JP-A-2010-113207, a light-emitting element or a light-receiving element is mounted on a flexible printed circuit board on which an optical waveguide is provided. On the flexible printed circuit board, a groove for coupling a core of the optical fiber to a core of the optical waveguide is provided. The optical fiber is connected to the optical waveguide by fixing an end portion of the optical fiber to the groove.

When the end portion of the optical fiber is fixed to the groove on the flexible printed circuit board as is in the photoelectric conversion module disclosed in JP-A-2010-113207, it is preferable that an end portion of the optical fiber be arranged as near an end face of the optical waveguide including an end face of a core thereof (hereinafter, referred to as “core end face”) as possible so that the core end face of the optical waveguide is in contact with and is connected to the end face of the optical fiber.

However, there is a problem that it is difficult to surely arrange the end face of the optical fiber on the core end face of the optical waveguide due to warping of the optical fiber or warping of the flexible printed circuit board.

### SUMMARY OF THE INVENTION

When the end portion of the optical fiber is fixed to the groove on the flexible printed circuit board as is in the photoelectric conversion module disclosed in JP-A-2010-113207, it is preferable that an end portion of the optical fiber be arranged as near an end face of the optical waveguide including an end face of a core thereof (hereinafter, referred to as “core end face”) as possible so that the core end face of the optical waveguide is in contact with and is connected to the end face of the optical fiber.

However, there is a problem that it is difficult to surely arrange the end face of the optical fiber on the core end face of the optical waveguide due to warping of the optical fiber or warping of the flexible printed circuit board.

Accordingly, it is an object of the invention to provide an optical fiber connection method that allows an end face of an optical fiber to be surely arranged on a core end face of an optical waveguide to connect the optical fiber to the optical waveguide, and an optical fiber connecting device.

(1) According to one embodiment of the invention, an optical fiber connection method for connecting an optical fiber to an optical waveguide on a circuit board comprises:

arranging an end portion of the optical fiber along a groove such that an end face of the optical fiber contacts with a core end face of the optical waveguide, the groove being formed on the circuit board and extending to the core end face of the optical waveguide, wherein an extended portion of the optical fiber extending out of the groove is arranged being inclined at a predetermined inclination angle with respect to the circuit board;

pressing an optical fiber hold-down member against the circuit board by a pressing member while arranging the optical fiber hold-down member on the circuit board via an adhesive so as to cover the end portion of the optical fiber; and

curing the adhesive while pressing the optical fiber hold-down member against the circuit board.

In the above embodiment (1) of the invention, the following modifications and changes can be made.

(i) The circuit board and the optical waveguide have flexibility.

(ii) The predetermined inclination angle in the arranging of the optical fiber is not less than 5° and not more than 30°.

(iii) The adhesive comprises an ultraviolet curable resin, wherein the pressing member and the optical fiber hold-down member comprise a ultraviolet transmitting member, and wherein the curing of the adhesive is conducted such that an ultraviolet ray is irradiated on the ultraviolet curable resin through the pressing member and the optical fiber hold-down member to cure the ultraviolet curable resin.

(iv) The pressing of the optical fiber hold-down member is conducted such that the optical fiber hold-down member is pressed against the circuit board while applying a pressing force to the pressing member at two or more positions distant from each other.

(v) The pressing member comprises a protrusion that protrudes toward the optical fiber hold-down member to contact with the optical fiber hold-down member, and wherein an area of a surface of the protrusion facing the optical fiber hold-down member is smaller than an area of a surface of the optical fiber hold-down member facing the protrusion.

(vi) The optical fiber and the optical fiber hold-down member comprise a glass.

(2) According to another embodiment of the invention, an optical fiber connecting device for connecting an optical fiber to an optical waveguide provided on a circuit board comprises:

a fixing device comprising a stage for placing the circuit board and a pressing member for pressing the circuit board toward the stage; and

a guide device to arrange an end portion of the optical fiber along a groove such that an end face of the optical fiber contacts with a core end face of the optical waveguide, the groove being formed on the circuit board and extending to the core end face of the optical waveguide, wherein the guide device is capable of holding the optical fiber while being inclined at a predetermined inclination angle with respect to an upper surface of the stage in order to allow an extended portion of the optical fiber extending out of the groove to be arranged being inclined at the predetermined inclination angle with respect to the circuit board.

Points of the Invention

According to one embodiment of the invention, an optical fiber connection method is conducted such that an extended portion of an optical fiber extending out of a groove for guiding the optical fiber is arranged being inclined with respect to an surface (i.e., a plane parallel to the groove) of FPC (flexible printed circuit board). By obliquely arranging the extended portion of the optical fiber in the groove, a restoring force to straighten with respect to the extended portion acts on the end portion of the optical fiber to allow the end portion of the optical fiber to move toward the core end face of a polymer optical waveguide along the groove. Thus, the end face of the optical fiber can be surely contacted with the core end face of the polymer optical waveguide.

### BRIEF DESCRIPTION OF THE DRAWINGS

Next, the present invention will be explained in more detail in conjunction with appended drawings, wherein:

FIG. 1 is a schematic cross sectional view showing a photoelectric conversion module manufactured using an optical fiber connection method in an embodiment;

FIG. 2 is a schematic exploded perspective view showing the photoelectric conversion module in FIG. 1;

FIG. 3 is a schematic front view showing a fixing device which constitutes an optical fiber connecting device in the embodiment;

FIG. 4 is a schematic perspective view showing a frame member and a pressing member which are used for the fixing device in FIG. 3;

FIG. 5 is an explanatory diagram illustrating the optical fiber connecting device and the optical fiber connection method in the embodiment; and

FIG. 6 is an explanatory diagram illustrating the optical fiber connection method in the embodiment.

### DETAILED DESCRIPTION OF THE PREFERRED EMBODIMENTS

An embodiment of the invention will be described below in reference to the drawings.

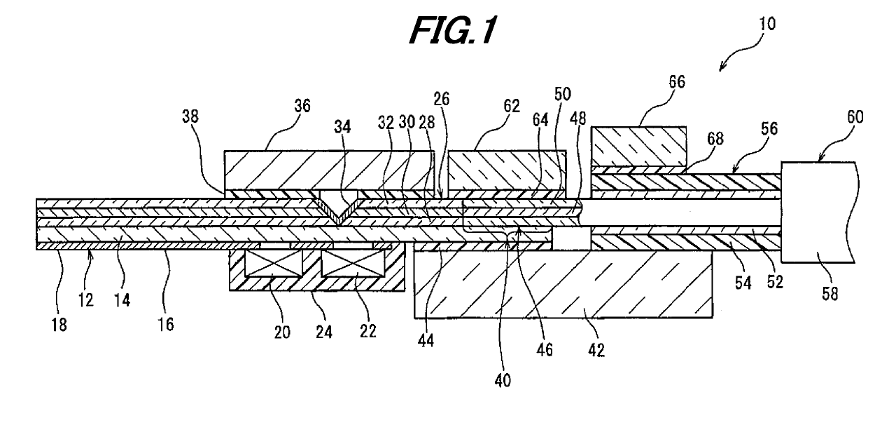

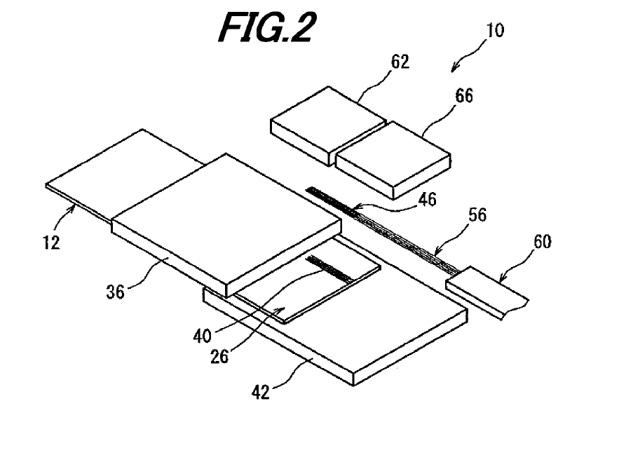

FIG. 1 is a schematic cross sectional view showing a photoelectric conversion module 10 and FIG. 2 is a schematic partial exploded perspective view showing the photoelectric conversion module 10.

As shown in FIGS. 1 and 2, the photoelectric conversion module 10 has a FPC board (flexible printed circuit board) (circuit board) 12, a photoelectric conversion element 22 mounted on one surface of the FPC board 12, and a polymer optical waveguide (optical waveguide) 26 provided on another surface of the FPC board 12. In the photoelectric conversion module 10, an end portion of an optical fiber 46 located on the polymer optical waveguide 26 side is fixed to the other surface of the FPC board 12. The optical fiber 46 is connected to the polymer optical waveguide 26.

The FPC board 12 is composed of a film 14 formed of, e.g., polyimide and having flexibility as well as translucency, and a conductor pattern 16 provided on the film 14 and formed of, e.g., metal such as copper.

The conductor pattern 16 of the FPC board 12 includes plural electrode terminals 18 formed at an end portion of the film 14. When using the photoelectric conversion module 10, the electrode terminals 18 are connected to a non-illustrated connector. The conductor pattern 16 can be made by, e.g., etching a metal film which is formed on the film 14.

An IC (integrated circuit) chip 20 and the photoelectric conversion element 22 are mounted on the one surface of the FPC board 12 at predetermined positions. The IC chip 20 and the photoelectric conversion element 22 are electrically connected to the conductor pattern 16.

The photoelectric conversion element 22 is a light-emitting element such as LD (laser diode) or a light-receiving element such as PD (photodiode). When the photoelectric conversion element 22 is a light-emitting element, the IC chip 20 is a driving circuit for the light-emitting element, and when the photoelectric conversion element 22 is a light-receiving element, the IC chip 20 is an amplifier circuit for amplifying output of the light-receiving element.

Alternatively, the photoelectric conversion element 22 may be an array element which includes plural light-emitting components or light-receiving components. As an example, four light-emitting components are included in the present embodiment.

The photoelectric conversion element 22 is a surface light-emitting type or a surface light-receiving type, and is arranged so that a light exit surface or a light incident surface thereof faces a surface of the FPC board 12. The IC chip 20 and the photoelectric conversion element 22 are covered by a potting member 24 which is formed of a resin.

The sheet-like polymer optical waveguide 26 having flexibility is integrally laminated all over the other surface of the FPC board 12.

The polymer optical waveguide 26 includes an under cladding layer 28, cores 30 and an over cladding layer 32. The under cladding layer 28 is laminated on the film 14 of the FPC board 12, and the core 30 having a square cross section extends on the under cladding layer 28. The number of the cores 30 is four so as to correspond to the number of light-emitting components of the photoelectric conversion element 22. The over cladding layer 32 is laminated on the under cladding layer 28 and the cores 30 so that the cores 30 are surrounded by the over cladding layer 32 and the under cladding layer 28.

Materials of the under cladding layer 28, the core 30 and the over cladding layer 32 are not specifically limited and it is possible to use, e.g., an acrylic-based resin, an epoxy-based resin and a polyimide-based resin, etc.

On the polymer optical waveguide 26, a V-shaped groove opening on a surface opposite to the FPC board 12 is formed and, for example, a metal film is formed on a wall surface of the V-shaped groove by vapor deposition. The metal film constitutes a mirror 34, and the mirror 34 is in contact with one end of the core 30. The core 30 is optically connected to the photoelectric conversion element 22 via the mirror 34.

A reinforcement plate 36 is fixed to the surface of the polymer optical waveguide 26 opposite to the FPC board 12. The reinforcement plate 36 is, e.g., a plate of metal such as copper, and faces the IC chip 20 and the photoelectric conversion element 22 so that the FPC board 12 is sandwiched therebetween. The reinforcement plate 36 is fixed using an adhesive layer 38 formed of, e.g., an adhesive of thermosetting resin, etc.

In addition, a groove for coupling a core of the optical fiber to the core 30 of the polymer optical waveguide 26 is formed on the FPC board 12. A groove 40 is formed so as to extend to an end face of the polymer optical waveguide 26 including an end face of the core 30 (hereinafter, referred to as “core 30-end face”). When the end portion of the optical fiber is fixed to the groove 40, the core of the optical fiber is optically coupled to the core 30 of the polymer optical waveguide 26. The groove 40 is provided so as to correspond to each core 30, and four grooves 40 are provided in the present embodiment. The grooves 40 extend in parallel to each other at predetermined intervals. The core 30-end face opposite to the mirror 34 constitutes an end face of one end of the groove 40. Another end of the groove 40 opens at an edge of the polymer optical waveguide 26.

The groove 40 is formed together with the polymer optical waveguide 26 by etching. In detail, a side wall of the groove 40 is composed of the under cladding layer 28 and the over cladding layer 32 of the polymer optical waveguide 26, and a bottom surface of the groove 40 is formed by the FPC board 12. Note that, a method of forming the groove 40 is not specifically limited and the groove 40 may be formed on the FPC board 12 by, e.g., using a guide member such as metal piece.

Furthermore, a supporting member 42 is fixed to the FPC board 12 on the surface opposite to the polymer optical waveguide 26. The supporting member 42 is preferably a glass plate and extends from the vicinity of the potting member 24 beyond the edge of the FPC board 12. A portion of the supporting member 42 overlapping the FPC board 12 supports the portion of the polymer optical waveguide 26 in which the grooves 40 are provided. The supporting member 42 is fixed using an adhesive layer 44 formed of, e.g., a thermosetting resin or an ultraviolet curable resin.

An end portion of the optical fiber 46 is arranged in each groove 40. The end face of the optical fiber 46 is arranged near the core 30-end face of the polymer optical waveguide 26. The optical fiber 46 is composed of a columnar core 48 and a clad 50 covering an outer peripheral surface of the core 48. The core 48 and the clad 50 are preferably formed of glass. The core 48 of the optical fiber 46 and the core 30 of the polymer optical waveguide 26 are coaxially arranged and are optically coupled to each other.

An extended portion of the optical fiber 46 extending out of the groove 40 is covered with an ultraviolet curable resin layer 52 and a resin sheath 54. The optical fiber 46, the ultraviolet curable resin layer 52 and the resin sheath 54 constitute a coated optical fiber 56. Portions of four coated optical fibers 56 extending beyond the supporting member 42 are covered all together with a resin covering 58 having a ribbon shape. The coated optical fibers 56 and the covering 58 constitute a ribbon fiber 60.

That is, an end portion of the coated optical fiber 56 is exposed by removing the covering 58 from the end portion of the ribbon fiber 60, and the end portion of the optical fiber 46 is exposed by removing the ultraviolet curable resin layer 52 and the sheath 54 from the end portion of the coated optical fiber 56.

An optical fiber hold-down member 62 is fixed to the polymer optical waveguide 26 and the optical fiber 46 so that the four grooves 40 with the end portions of the optical fibers 46 arranged therein and the end portion of the polymer optical waveguide 26 are covered all together. The optical fiber hold-down member 62 is a member which transmits visible light and ultraviolet rays. The optical fiber hold-down member 62 is formed of, e.g., a glass plate. The optical fiber hold-down member 62 is preferably fixed using an adhesive layer 64 formed of an ultraviolet curable resin to fix the end portion of the optical fiber 46 in the groove 40.

In addition, a sheath hold-down member 66 is fixed to the supporting member 42 so as to cover the four coated optical fibers 56 all together. The sheath hold-down member 66 is formed of, e.g., a glass plate. The sheath hold-down member 66 is preferably fixed using an adhesive layer 68 formed of an ultraviolet curable resin to fix the coated optical fibers 56 to the supporting member 42. In other words, the supporting member 42 supports the end portion of the optical fiber 46 arranged in the groove 40 and also the extended portion of the optical fiber 46 extending out of the groove 40.

Optical Fiber Connecting Device

An optical fiber connecting device for connecting the optical fiber 46 to the polymer optical waveguide 26 provided on the FPC board 12 will be described below.

The optical fiber connecting device is composed of a fixing device 100, a guide device 120, a dispenser 140 as an adhesive applicator and an ultraviolet lamp 150 as an ultraviolet irradiation device.

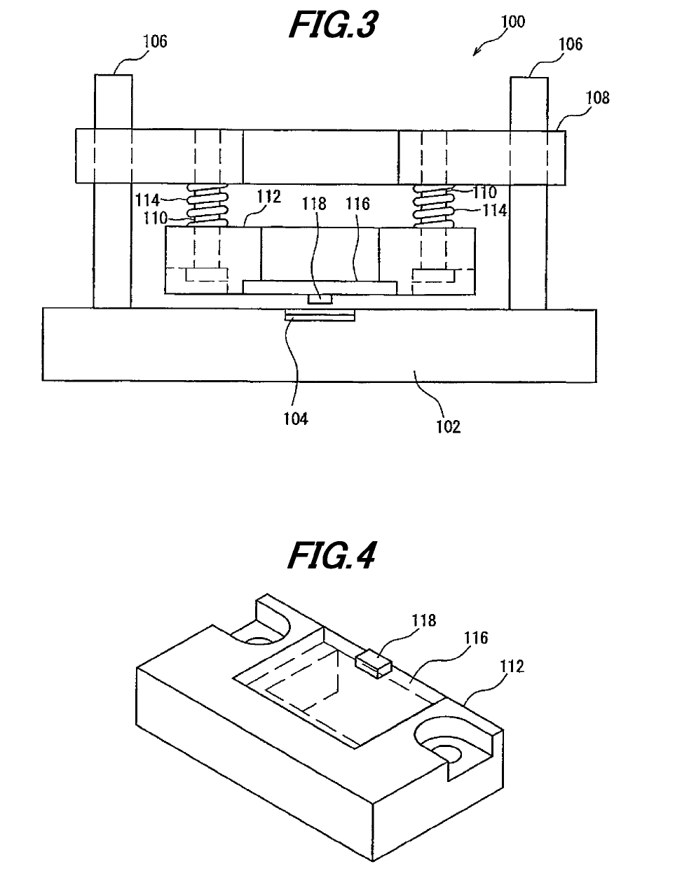

FIG. 3 is a front view showing a schematic configuration of the fixing device 100. The fixing device 100 has a stage 102 for mounting the FPC board 12. The stage 102 has an upper surface to be horizontally placed, and a recess 104 for receiving the supporting member 42 is formed on the upper surface of the stage 102. Two pillars 106 are vertically erected on the upper surface of the stage 102 and a slide member 108 vertically movable along the pillars 106 is attached to the pillars 106. The slide member 108 is movable toward the stage 102 by receiving a force from a non-illustrated drive source.

Two rod members 110 integrally protrude from the slide member 108 vertically toward the upper surface of the stage 102. A frame member 112 vertically movable along the rod members 110 is attached to the rod members 110. Two compression coil springs 114 are arranged between the slide member 108 and the frame member 112. The compression coil spring 114 is fitted to the rod member 110 and applies a force to the frame member 112 in a direction separating from the slide member 108, i.e., toward the upper surface of the stage 102.

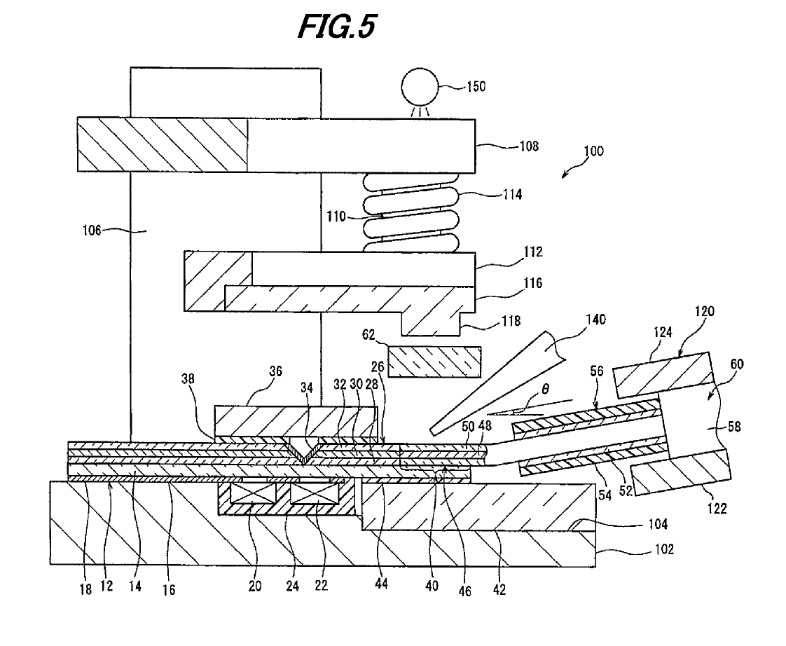

A pressing member 116 for pressing the FPC board 12 placed on the stage 102 toward the upper surface of the stage 102 is attached to the frame member 112. FIG. 4 is a schematic perspective view showing the frame member 112 and the pressing member 116. The frame member 112 has a C-shape in a plan view and the pressing member 116 is arranged so as to cover a center opening of the frame member 112. The pressing member 116 is a member which transmits visible light and ultraviolet rays. The pressing member 116 is formed of, e.g., a glass plate.

A rectangular parallelepiped-shaped protrusion 118 protruding toward the upper surface of the stage 102 is integrally provided on the pressing member 116. An area of a surface of the protrusion 118 facing the optical fiber hold-down member 62 is smaller than an area of a surface of the optical fiber hold-down member 62 facing the protrusion 118. The protrusion 118 is located between the rod members 110 when viewed in a width direction of the stage 102.

Referring to FIG. 5, the guide device 120 has, e.g., a guiding stage 122 and a hold-down member 124. The guiding stage 122 and the hold-down member 124 sandwich and hold the ribbon fiber 60 and maintain a predetermined posture of the optical fiber 46. In detail, the guiding stage 122 holds the optical fiber 46 in a state of being inclined at a predetermined inclination angle θ with respect to the upper surface of the stage 102. In other words, the extended portion of the optical fiber 46 extending out of the groove 40 is held so as to be inclined at a predetermined inclination angle θ with respect to the end portion of the optical fiber 46. Preferably, the inclination angle θ is set to not less than 5° and not more than 30°.

The dispenser 140 is a device for applying an ultraviolet curable resin as an adhesive to the periphery of the end portion of the optical fiber 46.

The ultraviolet lamp 150 is a device for irradiating ultraviolet rays on the ultraviolet curable resin. The ultraviolet lamp 150 is arranged above or obliquely above the pressing member 116 of the fixing device 100.

Optical Fiber Connection Method

An optical fiber connection method for connecting the optical fiber 46 to the polymer optical waveguide 26 provided on the FPC board 12 using the optical fiber connecting device will be described below.

Firstly, as shown in FIG. 5, the FPC board 12 having the polymer optical waveguide 26 provided thereon is placed on the upper surface of the stage 102. At this stage, the members except the optical fiber hold-down member 62 and the sheath hold-down member 66 have been already mounted on the FPC board 12 in the present embodiment.

After placing the FPC board 12 on the stage 102, the end portion of the optical fiber 46 is arranged along the groove 40 so that the end face of the optical fiber 46 is in contact with the core 30-end face of the polymer optical waveguide 26. At this time, the guide device 120 holds the ribbon fiber 60 in a region away from the end portion of the optical fiber 46 (an optical fiber arranging step). The guiding stage 122 holds the optical fiber 46 in a state of being inclined at a predetermined inclination angle θ, e.g., 5°, with respect to the upper surface of the stage 102. Accordingly, the extended portion of the optical fiber 46 extending out of the groove 40 is arranged so as to be inclined at a predetermined inclination angle θ with respect to the FPC board 12.

A predetermined amount of the ultraviolet curable resin is applied to the peripheries of the end portion of the optical fiber 46 and the end portion of the polymer optical waveguide 26 by the dispenser 140 in the state that the optical fiber 46 is held in a predetermined posture by the guide device 120.

Next, the optical fiber hold-down member 62 is arranged so as to cover the end portion of the optical fiber 46 arranged along the groove 40 as well as the end portion of the polymer optical waveguide 26 in a state that an uncured ultraviolet curable resin is interposed therebetween. The protrusion 118 of the pressing member 116 is brought into contact with the optical fiber hold-down member 62 and a pressing force toward the stage 102 is applied to the pressing member 116 by moving the slide member 108 of the fixing device 100 toward the stage 102, thereby pressing the optical fiber hold-down member 62 against the FPC board 12 (a pressing step). The protrusion 118 of the pressing member 116 is pressed so as not to protrude from the upper surface of the optical fiber hold-down member 62. At this time, a pressing force is applied to the pressing member 116 at two separate positions by the two compression coil springs 114.

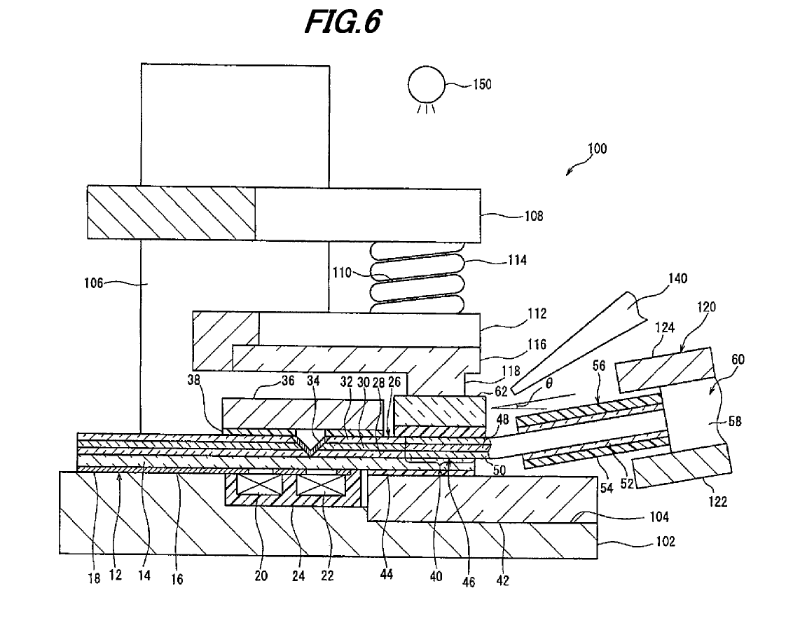

Next, as shown in FIG. 6, an ultraviolet ray is irradiated on the ultraviolet curable resin by the ultraviolet lamp 150 in a state that the optical fiber hold-down member 62 is pressed against the FPC board 12 (an adhesive curing step). The ultraviolet ray from the ultraviolet lamp 150 transmits through the pressing member 116 and the optical fiber hold-down member 62, and is irradiated on the ultraviolet curable resin. As a result, the ultraviolet curable resin is cured and the adhesive layer 64 is thereby formed.

As described above, the end portion of the optical fiber 46 is fixed to the groove 40 by the optical fiber hold-down member 62. After this, the sheath hold-down member 66 is fixed and the coated optical fiber 56 is then fixed to the supporting member 42, thereby finishing the photoelectric conversion module 10. After finishing the photoelectric conversion module 10, the portion of the optical fiber 46 extending out of the supporting member 42 is detached from the guide device 120 and extends along the supporting member 42.

In the optical fiber arranging step of the optical fiber connection method using the optical fiber connecting device in the embodiment, the end portion of the optical fiber 46 is arranged along the groove 40 extending to the core end face of the optical waveguide so that the end face of the optical fiber 46 is in contact with the core 30-end face of the polymer optical waveguide 26, and the extended portion of the optical fiber 46 extending out of the groove 40 is arranged so as to be inclined with respect to the FPC board 12.

By obliquely arranging the extended portion of the optical fiber 46, a restoring force to straighten with respect to the extended portion acts on the end portion of the optical fiber 46. This restoring force functions to move the end portion of the optical fiber 46 toward the core 30-end face of the polymer optical waveguide 26 along the groove 40. As a result, the end face of the optical fiber 46 can be surely contacted with the core 30-end face of the polymer optical waveguide 26.

In addition, since the restoring force acts, it is possible to surely arrange the end face of the optical fiber 46 on the core 30-end face of the polymer optical waveguide 26 even if the FPC board 12 is warped due to flexibility thereof or the optical fiber 46 is warped.

In addition, since it is possible to surely arrange the end face of the optical fiber 46 on the core 30-end face of the polymer optical waveguide 26, it is possible to fix the optical fiber 46 to the FPC board 12 in short time. As a result, mass production of the photoelectric conversion module 10 is facilitated.

In the optical fiber arranging step, the inclination angle θ of the extended portion of the optical fiber 46 with respect to the FPC board 12 is not less than 5° and not more than 30°. The inclination angle θ of not less than 5° and not more than 30° allows the preferred level of the restoring force to act on the end portion of the optical fiber 46.

When the inclination angle θ is less than 5°, it may not be possible to arrange the end face of the optical fiber 46 on the core 30-end face of the polymer optical waveguide 26 due to lack of the restoring force. When the inclination angle θ is more than 30°, a tip of the optical fiber 46 may pierce into the wall surface of the groove 40 or the optical fiber 46 may stick out of the groove 40 since the restoring force is too strong.

In addition, since the pressing force is applied to the pressing member 116 at two separate positions in the pressing step, the optical fiber hold-down member 62 is fixed to the FPC board 12 in parallel thereto without being inclined. Especially, since the pressing force is evenly applied to two positions by the compression coil springs 114 as an elastic member, inclination of the optical fiber hold-down member 62 is surely prevented. By preventing the inclination of the optical fiber hold-down member 62 as described above, the uncured ultraviolet curable resin is prevented from spreading to an undesired region.

In addition, in the adhesive curing step, since the optical fiber hold-down member 62 and the pressing member 116 are members which transmit ultraviolet rays, it is possible to irradiate ultraviolet rays on the ultraviolet curable resin through the optical fiber hold-down member 62 and the pressing member 116 in the state that the optical fiber hold-down member 62 is pressed against the FPC board 12. Furthermore, it is possible to visually confirm the alignment of the end portion of the optical fiber 46 since the optical fiber hold-down member 62 and the pressing member 116 are members which transmit visible light, and this also makes the end portion of the optical fiber 46 accurately fixed.

And also, the pressing member 116 used for the optical fiber connecting device in the embodiment has the protrusion 118 which protrudes toward the optical fiber hold-down member 62 and is brought into contact therewith. The area of the surface of the protrusion 118 facing the optical fiber hold-down member 62 is smaller than the area of the surface of the optical fiber hold-down member 62 facing the protrusion 118. Therefore, the uncured ultraviolet curable resin squeezed out at the time of pressing the optical fiber hold-down member 62 against the FPC board 12 can be prevented from adhering to the pressing member 116.

It is preferable that the optical fiber 46 and the optical fiber hold-down member 62 be formed of glass. Since this makes a linear expansion coefficient of the optical fiber 46 and that of the optical fiber hold-down member 62 substantially equal, separation of the optical fiber hold-down member 62 caused by a difference in thermal expansion is prevented.

The invention is not limited to the embodiment and includes also modification of the embodiment.

For example, although the end portions of the four optical fibers 46 are fixed to the FPC board 12 in the embodiment, the number of the optical fibers 46 to be fixed only needs to be one or more. In addition, a specific configuration of the photoelectric conversion module 10 to be manufactured is not limited to the configuration in the embodiment.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. An optical fiber connection method for connecting an optical fiber to an optical waveguide on a circuit board, comprising:
arranging an end portion of the optical fiber along a groove such that an end face of the optical fiber contacts with a core end face of the optical waveguide, the groove being formed on the circuit board and extending to the core end face of the optical waveguide, wherein an extended portion of the optical fiber extending out of the groove is arranged being inclined at a predetermined inclination angle with respect to the circuit board;
pressing an optical fiber hold-down member against the circuit board by a pressing member while arranging the optical fiber hold-down member on the circuit board via an adhesive so as to cover the end portion of the optical fiber; and
curing the adhesive while pressing the optical fiber hold-down member against the circuit board.

2. The method according to claim 1, wherein the circuit board and the optical waveguide have flexibility.

3. The method according to claim 1, wherein the predetermined inclination angle in the arranging of the optical fiber is not less than 5° and not more than 30°.

4. The method according to claim 1, wherein the adhesive comprises an ultraviolet curable resin,
wherein the pressing member and the optical fiber hold-down member comprise a ultraviolet transmitting member, and
wherein the curing of the adhesive is conducted such that an ultraviolet ray is irradiated on the ultraviolet curable resin through the pressing member and the optical fiber hold-down member to cure the ultraviolet curable resin.

5. The method according to claim 1, wherein the pressing of the optical fiber hold-down member is conducted such that the optical fiber hold-down member is pressed against the circuit board while applying a pressing force to the pressing member at two or more positions distant from each other.

6. The method according to claim 1, wherein the pressing member comprises a protrusion that protrudes toward the optical fiber hold-down member to contact with the optical fiber hold-down member, and
wherein an area of a surface of the protrusion facing the optical fiber hold-down member is smaller than an area of a surface of the optical fiber hold-down member facing the protrusion.

7. The method according to claim 1, wherein the optical fiber and the optical fiber hold-down member comprise a glass.

8. An optical fiber connecting device for connecting an optical fiber to an optical waveguide provided on a circuit board, comprising:
a fixing device comprising a stage for placing the circuit board and a pressing member for pressing the circuit board toward the stage; and
a guide device to arrange an end portion of the optical fiber along a groove such that an end face of the optical fiber contacts with a core end face of the optical waveguide, the groove being formed on the circuit board and extending to the core end face of the optical waveguide, wherein the guide device is capable of holding the optical fiber while being inclined at a predetermined inclination angle with respect to an upper surface of the stage in order to allow an extended portion of the optical fiber extending out of the groove to be arranged being inclined at the predetermined inclination angle with respect to the circuit board.
